(19) United States
(12) Patent Application Publication
(10) Pub. No.: US 2013/0038080 A1
(43) Pub. Date: Feb. 14, 2013

(54) STOWABLE UNDER-SEAT STORAGE SYSTEM AND METHOD OF ORGANIZING A PASSENGER COMPARTMENT OF A VEHICLE

(71) Applicant: Edward D. Tate, JR., Grand Blanc, MI (US)

(72) Inventor: Edward D. Tate, JR., Grand Blanc, MI (US)

(73) Assignee: GM GLOBAL TECHNOLOGY OPERATIONS LLC, Detroit, MI (US)

(21) Appl. No.: 13/207,490

(22) Filed: Aug. 11, 2011

(51) Int. Cl. B60R 7/04; B23P 17/00

(52) U.S. Cl. 296/37.5; 29/426.2

(57) ABSTRACT

A vehicle includes a seat moveable between a horizontal seating position and a vertical raised position. An under-seat space is defined between a floor surface of the vehicle and a bottom surface of the seat. A collapsible storage system is stowable under the seat, flat against the bottom surface of the seat when not needed for storage, and is positionable on the floor to define a lateral boundary wall to convert the under-seat space into an enclosed storage space.

### TECHNICAL FIELD

The invention generally relates to a storage system for converting an under-seat space disposed between a floor surface and a bottom surface of a seat into an enclosed storage space, and a method of organizing a passenger compartment of the vehicle with the storage system.

### BACKGROUND

Vehicles having a rear seat, including but not limited to extended cab pick-up trucks, may utilize an under-seat space disposed between a floor surface of the passenger compartment and a bottom surface of the seat for storage. The seat pivots between a substantially horizontal seating position, and a substantially vertical raised position to provide vertical access to the under-seat space from above. A tub having fixed walls may be positioned under the seat to define a lateral boundary wall for containing objects within the tub, under the seat. However, if these tubs are not needed for storage, they must either remain in place, or must be completely removed from the vehicle and stored as a whole in-shape unit.

### SUMMARY

A vehicle is provided. The vehicle includes a body that defines a passenger compartment having a floor surface. A seat is supported by and attached to the body. The seat is moveable between a seating position and a raised position. When in the seating position, the seat defines an under-seat space between the seat and the floor surface. When in the raised position, the seat allows vertical access to the under-seat space from above. The vehicle further includes a storage system. The storage system includes a panel that is positionable on the floor surface to extend vertically. The panel extends vertically to define a lateral boundary wall to convert the under-seat space into an enclosed storage space. The panel is collapsible for storage adjacent a bottom surface of the seat.

A method of organizing a passenger compartment of a vehicle is also provided. The method includes raising a seat from a substantially horizontal seating position to a substantially vertical raised position to expose a collapsible storage system concealed flat against a bottom surface of the seat. The collapsible storage system is de-coupled from the seat, and attached to a floor surface of the passenger compartment to define a lateral boundary wall. The lateral boundary wall converts an under-seat space disposed between the floor surface and the bottom surface of the seat into an enclosed storage space.

Accordingly, the storage system may be positioned on the floor surface to define the enclosed storage space for storing objects therein. The panel of the storage system defines the lateral boundary wall, which prevents the objects from sliding out of the enclosed storage space. When not needed for storage, the storage system may be detached from the floor surface, collapsed flat, and secured to a bottom surface of the seat, out of the way, thereby opening up access to the under-seat space.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle showing a rear seat of a passenger compartment in a seating position.

FIG. 2 is a schematic perspective view of the vehicle showing the rear seat in a raised position, thereby exposing a concealed storage system stored flat against a bottom surface of the seat.

FIG. 3 is a schematic perspective view of the vehicle showing the rear seat in the raised position and the storage system positioned on the floor surface to define an enclosed storage space.

FIG. 4 is a schematic perspective view of the vehicle showing the rear seat in the seating position and the storage system positioned on the floor surface to define an enclosed storage space.

FIG. 5 is a schematic cross sectional view of the vehicle showing a floor attachment mechanism and a seat attachment mechanism.

FIG. 6 is a schematic front view of the vehicle showing the storage system positioned on the floor surface from above.

FIG. 7 is a schematic perspective view of an embodiment of the storage system in which a panel includes a flexible net supported by a frame.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

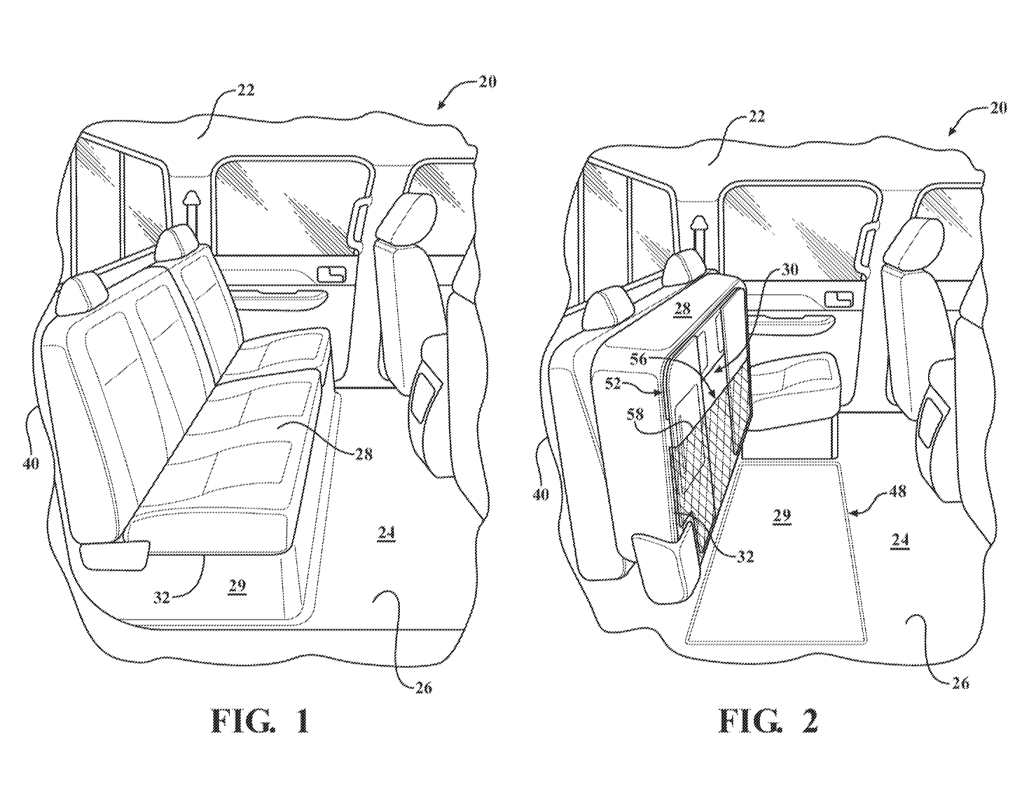

Referring to the Figures, wherein like numerals indicate like parts throughout the several views, a vehicle is generally shown at 20. Referring to FIGS. 1 through 4, the vehicle 20 may include any type and/or style of vehicle 20, such as but not limited to the extended cab pick-up truck shown. The vehicle 20 includes a body 22 that defines a passenger compartment 24. The passenger compartment 24 includes a floor surface 26, which defines a bottom or lower interior surface of the passenger compartment 24.

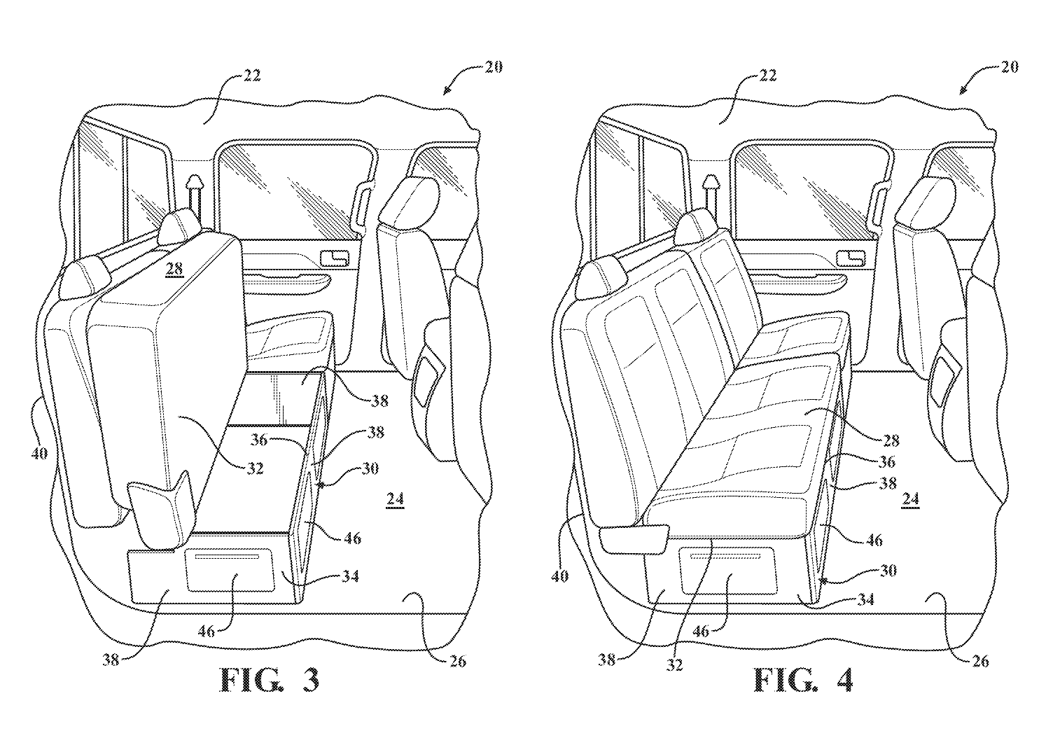

A seat 28 is supported by and attached to the body 22. As shown, the seat 28 includes a rear passenger seat 28 of the vehicle 20. However, it should be appreciated that the seat 28 may be positioned at any location within the passenger compartment 24. As shown, the seat 28 includes a bench seat 28. However, the seat 28 may include some other style and/or configuration of seat 28 not shown or described herein. The seat 28 is moveable between a seating position, shown in FIGS. 1 and 4, and a raised position, shown in FIGS. 2 and 3. When in the seating position, the seat 28 is positioned substantially horizontal relative to the floor surface 26 and cooperates with the floor surface 26 to define an under-seat space 29 between the seat 28 and the floor surface 26, shown in FIG. 1. The seat 28 pivots upward from the seating position into the raised position. The seat 28 is disposed in a substantially vertical position relative to the floor surface 26 when positioned in the raised position. When the seat 28 is positioned in the raised position, the seat 28 allows vertical access from above to the under-seat space 29.

The vehicle 20 includes a storage system 30 for converting the under-seat space 29 beneath the seat 28 into a storage space. As shown in FIG. 2, when not in use to define the storage space, the storage system 30 is collapsed and stowed underneath a bottom surface 32 of the seat 28. Referring to FIGS. 3, 4 and 6, the storage system 30 includes a panel 34. The panel 34 may be positioned on the floor surface 26 to define the storage space, or may be collapsed and stowed adjacent the bottom surface 32 of the seat 28 when the storage space is not required, as shown in FIG. 2. When positioned on the floor surface 26 to define the storage space, the panel 34 extends vertically upward from the floor surface 26, and defines a lateral boundary wall 36 to convert the under-seat space 29 into the enclosed storage space. The lateral boundary wall 36 at least partially defines a lateral edge surface that bounds the storage space and prevents objects within the storage space from sliding outside of the storage space and out from underneath the seat 28.

As shown in FIG. 4, when the panel 34 is positioned to define the lateral boundary wall 36 and the seat 28 is disposed in the seating position, the panel 34 may extend fully between the floor surface 26 and the bottom surface 32 of the seat 28. However, it should be appreciated that the panel 34 need not extend fully between the floor surface 26 and the bottom surface 32 of the seat 28, and may alternatively extend from the floor surface 26 to a height above the floor surface 26 that is spaced vertically below the bottom surface 32 of the seat 28.

The panel 34 may include a rigid member 38, and may be formed from a rigid material including but not limited to a plastic material. Preferably, the panel 34 includes a plurality of rigid members 38. When positioned on the floor surface 26 to define the lateral boundary wall 36, the plurality of rigid members 38 is coupled together. The plurality of rigid members 38 may be coupled together in any suitable manner, including but not limited to coupling the rigid members 38 together with clips, hinges, or fasteners. As best shown in FIG. 6, the rigid members 38 of the panel 34 define three vertical walls, and cooperate with a back wall 40 of the vehicle 20 to further define the enclosed storage space. The plurality of rigid members 38 may be separate from each other and configured for attachment together to define the lateral boundary wall 36. Alternatively, the plurality of rigid members 38 may be moveably linked together, for example through pivotal and/or hinge connections.

Referring to FIG. 6, the storage system 30 may be configured to define any suitable size and/or shape. Furthermore, the storage system 30 may include a lid member 42 and one or more partition members 44. The lid member 42 is configured for covering the enclosed storage space, and the partition member 44 is configured for partitioning the enclosed storage space into compartments. The lid member 42 and/or the partition member 44 may be separate and independent pieces from the panel 34 and configured for attachment to the panel 34, or may be moveably affixed to the panel 34 through pivotal and/or hinge connections.

Referring to FIGS. 3 and 4, the panel 34, and more specifically the rigid member 38, may define a panel door 46. The panel door 46 permits horizontal access to the enclosed storage space. The panel 34 may include several panel door 46s, allowing access to various locations and/or partitions of the storage space. The panel door 46 is preferably hinged to the panel 34 for rotation, and includes a clasp for securing the panel door 46 in a closed position.

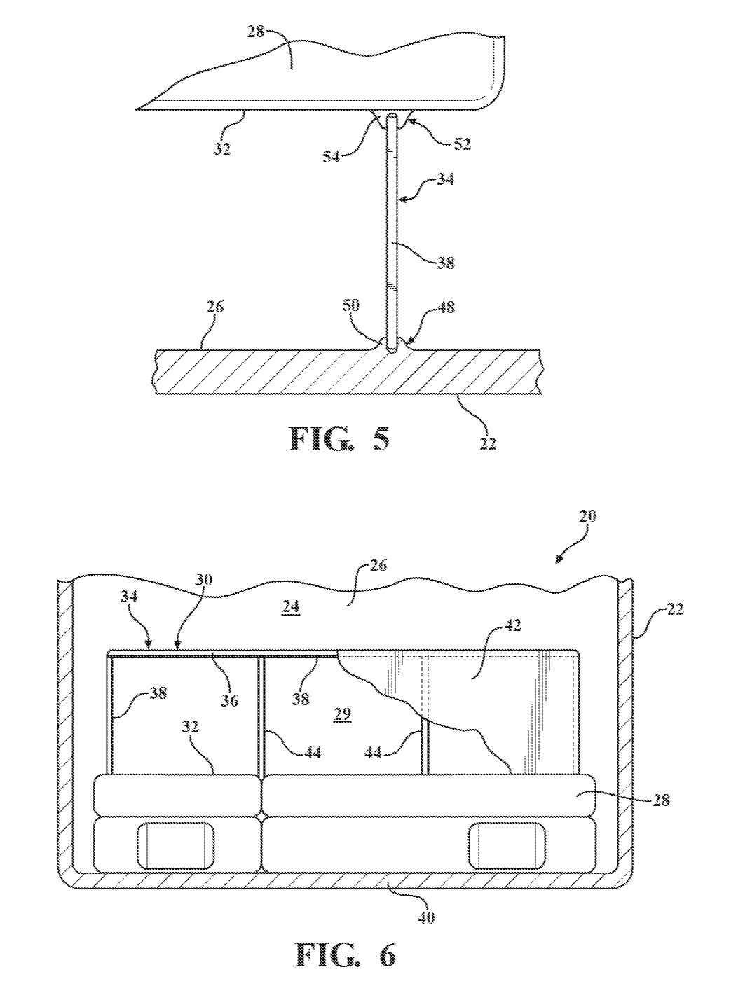

Referring to FIG. 5, a floor attachment mechanism 48 releasably attaches the panel 34 to the floor surface 26. The floor attachment mechanism 48 may include any suitable mechanism capable of releasably attaching the panel 34 to the floor surface 26. For example, the floor attachment mechanism 48 may include a floor clip 50 secured to the floor surface 26, and configured for engaging the panel 34 in interlocking engagement. To attach the panel 34 to the floor surface 26, the panel 34 is snapped into the floor clip 50 such that the floor clip 50 prevents the panel 34 from moving relative to the floor surface 26. To remove the panel 34, the panel 34 is lifted upward out of the floor clip 50 with sufficient force to disengage the interlocking frictional engagement between the floor clip 50 and the panel 34. It should be appreciated that the floor attachment mechanism 48 may be configured in some other manner not shown or described herein.

The vehicle 20 may further include a seat attachment mechanism 52. Referring to FIG. 5, the seat attachment mechanism 52 is configured for releasably securing the panel 34 to the bottom surface 32 of the seat 28 when the seat 28 is disposed in the seating position. The seat attachment mechanism 52 may include any suitable mechanism capable of releasably securing the panel 34 to the bottom surface 32 of the seat 28. For example, the seat attachment mechanism 52 may include a seat clip 54 secured to the bottom surface 32 of the seat 28, and configured for engaging the panel 34 in interlocking engagement. To secure the panel 34 relative to the bottom surface 32 of the seat 28, the seat 28 is rotated downward into the seating position from the raised position so that the seat clip 54 snaps over a top edge of the panel 34 such that the seat clip 54 prevents the top edge of the panel 34 from moving relative to the seat 28. To disengage the seat attachment mechanism 52, the seat 28 is rotated upward into the raised position with sufficient force to disengage the interlocking frictional engagement between the seat clip 54 and the panel 34. It should be appreciated that the seat attachment mechanism 52 may be configured in some other manner not shown or described herein.

Referring to FIG. 2, the seat 28 includes a storage mechanism 56 disposed on the bottom surface 32 of the seat 28. The storage mechanism 56 is configured for storing the panel 34 when the panel 34 is not positioned on the floor surface 26 to define the lateral boundary wall 36. The storage mechanism 56 may include any mechanism capable of stowing the panel 34 in place underneath and against the bottom surface 32 of the seat 28. For example, the storage mechanism 56 may include a sleeve 58 attached to the bottom surface 32 of the seat 28. The sleeve 58 is configured for slideably receiving and supporting the panel 34 therein. Accordingly, when the panel 34 is not needed to define the lateral boundary wall 36 of the storage space, the panel 34 may be detached from the floor attachment mechanism 48, collapsed and/or folded down into a flat structure, and slid into the sleeve 58 for storage, out of the way and without obstructing the under-seat space 29. Alternatively, the storage mechanism 56 may include one or more moveable connections interconnecting the seat 28 and the panel 34. When the panel 34 is not needed to define the lateral boundary wall 36 of the storage space, the panel 34 may be folded flat and secured to the bottom surface 32 of the seat 28, with the moveable connections allowing the panel 34 to rotate and/or swing relative to the seat 28 while still supporting the panel 34 relative to the seat 28.

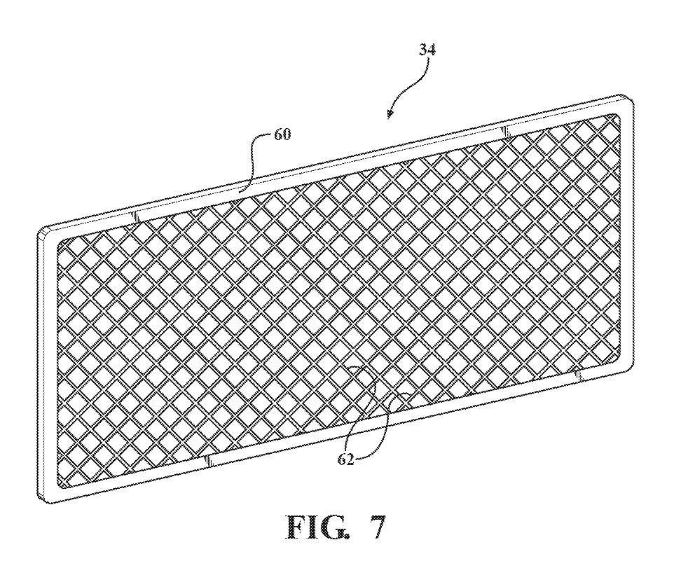

While the panel 34 has thus far been described as including one or more rigid members 38, it should be appreciated that the panel 34 may alternatively include some other configuration. For example, referring to FIG. 7, the panel 34 may include a frame 60 defining a perimeter structure, with the frame 60 supporting a netting 62 thereabouts. It should be appreciated that the frame 60 may include multiple sections that may be interconnected together to define the lateral boundary wall 36.

While the best modes for carrying out the invention have been described in detail, those familiar with the art to which this invention relates will recognize various alternative designs and embodiments for practicing the invention within the scope of the appended claims.

1. A vehicle comprising:
a body defining a passenger compartment having a floor surface;
a seat supported by and attached to the body and moveable between a seating position defining an under-seat space between the seat and the floor surface and a raised position allowing vertical access to the under-seat space from above; and
a storage system having a panel positionable on the floor surface to extend vertically to define a lateral boundary wall to convert the under-seat space into an enclosed storage space; and
wherein the panel is collapsible and configured for storage adjacent a bottom surface of the seat.

2. A vehicle as set forth in claim 1 wherein the panel extends between the floor surface and the bottom surface of the seat when the seat is disposed in the seating position and the panel is positioned to define the lateral boundary wall.

3. A vehicle as set forth in claim 2 further comprising a floor attachment mechanism configured for releasably attaching the panel to the floor surface.

4. A vehicle as set forth in claim 3 wherein the floor attachment mechanism includes a floor clip secured to the floor surface for engaging the panel in interlocking engagement.

5. A vehicle as set forth in claim 3 further comprising a seat attachment mechanism configured for releasably securing the panel to the bottom surface of the seat when the seat is disposed in the seating position.

6. A vehicle as set forth in claim 5 wherein the seat attachment mechanism includes a seat clip secured to the seat for engaging the panel in interlocking engagement.

7. A vehicle as set forth in claim 1 wherein the panel includes a rigid member.

8. A vehicle as set forth in claim 7 wherein the rigid member defines a door permitting horizontal access to the enclosed storage space.

9. A vehicle as set forth in claim 7 wherein the rigid member includes a plurality of rigid members.

10. (canceled)

11. (canceled)

12. A vehicle as set forth in claim 1 wherein the panel includes a frame defining a perimeter structure supporting a netting thereabout.

13. A vehicle as set forth in claim 1 wherein the seat includes a storage mechanism disposed on the bottom surface of the seat and configured for storing the panel when the panel is not positioned on the floor surface to define the lateral boundary wall.

14. A vehicle as set forth in claim 13 wherein the storage mechanism includes a sleeve attached to the bottom surface of the seat and configured for receiving and supporting the panel therein.

15. A vehicle as set forth in claim 1 wherein the storage system includes a lid member configured for covering the enclosed storage space when the panel is positioned on the floor surface to define the lateral boundary wall.

16. A vehicle as set forth in claim 1 wherein the panel includes a partition member configured for partitioning the enclosed storage space into compartments.

17. A method of organizing a passenger compartment of a vehicle, the method comprising:
raising a seat from a substantially horizontal seating position to a substantially vertical raised position to expose a collapsible storage system including a plurality of rigid members concealed under a bottom surface of the seat;
de-coupling the collapsible storage system from the seat;
attaching the plurality of rigid members of the collapsible storage system to a floor surface of the passenger compartment to define a lateral boundary wall that converts an under-seat space disposed between the floor surface and the bottom surface of the seat into an enclosed storage space.

18. A method as set forth in claim 17 wherein the collapsible storage system includes a panel defining a door, and wherein the method includes opening the door to access the enclosed storage space from a horizontal direction.

19. A method as set forth in claim 18 further comprising stowing the collapsible storage system flat against the bottom surface of the seat when not positioned to define the lateral boundary wall.
